(19) United States
(12) Patent Application Publication
(10) Pub. No.: US 2006/0060436 A1
(43) Pub. Date: Mar. 23, 2006

(54) Element for packaging a brake disc and module comprising at least one such element

(76) Inventors: Arnaud Metayer, Marly Le Roi (FR); Patrick Sachot, Beaufort En Vallee (FR)

Correspondence Address: LEO H MCCORMICK, 2112 MISHAWAKA AVE, P O BOX 4721, SOUTH BEND, IN, 46634, US

(21) Appl. No.: 10/534,848

(22) PCT Filed: Jun. 5, 2003
(86) PCT No.: PCT/EP03/05911

§ 371 Date: May 13, 2005

(30) Foreign Application Priority Data
Nov. 15, 2002 (FR) 02/14990

(51) Int. Cl. F16D 65/12

(52) U.S. Cl. 188/218 XL

(57) ABSTRACT

A storage element for at least one brake disc comprising a housing (13) equipped with at least one annular shoulder (15) coming into contact with a radially external annular end of the brake disc so as to reduce the risk of damage to the surface finish of the disc.

The present invention relates mainly to a brake disc storage element and to a module comprising at least one such element.

A motor vehicle brake disc of known type generally comprises first and second brake pads facing each other and applied, when a braking action is exerted, by a piston against first and second friction tracks borne by a brake disc, the said brake disc being secured to a hub of the motor vehicle.

A brake disc has a first and second face, the first face comprising a projecting cylindrical. central part equipped with a central through-orifice surrounded by fixing orifices whereby it is fixed by a screw and nut system to the hub of the motor vehicle.

The first and second faces respectively comprise the more or less annular first and second friction tracks.

The brake disc is produced by machining a steel casting, then the workpiece is machined and, in most cases, covered with anti-corrosion protection. This is because since the brake disc is located at the wheels of the motor vehicle, this disc is highly exposed to rainwater, to sea spray in coastal regions, and, during the winter months, to the materials used to salt the roads exposed to the risks of black ice, and the presence of corrosion on the tracks of the brake disc is likely to reduce the braking quality and also to cause corrosion of elements of which the disc brake is composed, for example the piston and its housing, thus impeding the correct sliding of the piston.

It is therefore necessary to preserve this anti-corrosion protection once it has been applied, particularly while the brake discs are being transported between the brake disc manufacturing site and the motor vehicle assembly site.

In addition, a check of the centre of the brake disc is performed after the disc has been mounted on its hub, the inspection being performed over a circle the periphery of which lies a distance of about 10 mm from the radially external end of the disc. Now, any scoring as the control circle passes may impede the check.

Motor vehicle manufacturers are also more inclined to reject brake discs that have friction tracks whose surface finish is not without blemish even if the scoring is not very deep and does not in any way adversely affect the braking qualities of the brake disc.

Now, the current ways of stocking and storing brake discs with a view to transporting these, cause fairly significant scoring. This is because the brake discs are stored flat, resting via the second face of the brake disc on a plate that allows several discs to be handled at the same time. However, small-sized foreign bodies can become trapped between the handling plate and the friction track and, because the brake disc slips as the plates are being moved around, the trapped particles may score into the anti-corrosion protection. There are other types of plates comprising cylindrical blocks projecting from the surface on which the disc rests and entering the central orifice of the disc so as to limit the transverse movement of the disc. However, the presence of this block impedes the fitter in his attempts to grasp hold of the disc.

In addition, it is commonplace for the transport plates to be stacked up and so at the present time the discs take the load of the plates above, and this leads to the risk not only of damaging the surface finish of the discs but above all of deforming the discs, thus rendering them unserviceable.

It is therefore an object of the present invention to offer a brake disc storage element that spares the brake discs, particularly their surface finish, and especially the flatness control region.

Another object of the present invention is to offer a storage element able to accept several types of brake disc, that is to say ones of different diameters.

Another object of the present invention is to offer a storage element that allows ease of grasping of the brake discs.

Another object of the present invention is to offer a brake disc storage element that is simple in design and low in cost price.

Another object of the present invention is to offer a means for storing and transporting a great many brake discs.

These objects are achieved by a brake disc storage element comprising means holding the brake disc in place transversely with a small amount of contact between the faces of the brake disc and the storage element.

In other words, the brake disc rests against the storage element via a radially external end of one face of the brake disc.

The main subject of the present invention is a storage element for at least one brake disc comprising at least one housing of longitudinal axis, the housing comprising, at a first longitudinal end, an opening for inserting the said brake disc having an internal diameter greater than the external diameter of the brake disc, a wall connecting the first longitudinal end to a second longitudinal end, characterized in that the said housing comprises at least one suspension means made in the said wall of the said brake disc so that a non-zero distance separates a first or second face of the brake disc, facing towards the second longitudinal end of the housing and the said second end.

Another object of the present invention is a storage element for a brake disc, characterized in that the said suspension means is formed by at least one shoulder connecting a first portion of the brake disc and a smaller-diameter second portion of longitudinal axis, the said shoulder being of width such that the shoulder collaborates with a radially external end of the said first or second face of the brake disc.

Another subject of the present invention is an element characterized in that the shoulder is made of at [sic] two parts arranged in one and the same plane and formed by angular sectors distributed, advantageously uniformly, over the periphery of the housing.

Another subject of the present invention is a storage element for a brake disc, characterized in that the housing comprises several shoulders arranged in parallel planes so that the storage element will take brake discs of different diameters.

Another subject of the present invention is an element characterized in that each shoulder connects a larger-diameter part to a smaller-diameter part, the said smaller-diameter part forming the next larger-diameter part, and in that each larger-diameter part has an axial dimension along the axis at least equal to half the distance separating the first and second faces of the brake disc it accommodates.

Another subject of the present invention is a storage element for a brake disc, characterized in that the smaller-diameter portion of the previous suspension means along the longitudinal axis from the first end of the housing towards the second end forms the larger-diameter portion of the next suspension means.

Another subject of the present invention is a storage element characterized in that the width of the shoulder is preferably between 4 mm and 10 mm.

Another subject of the present invention is a storage element characterized in that the width of the shoulder is more preferably still between 6 mm and 8 mm.

Another subject of the present invention is a storage element for a brake disc, characterized in that the wall is in the form of a cone frustum with the taper directed towards the second longitudinal end of the housing.

Another subject of the present invention is an element characterized in that the housing has a dimension along the axis at least equal to the dimension of the brake disc along the axis.

Another subject of the present invention is an element characterized in that it is made of a synthetic material by thermoforming.

Another subject of the present invention is an element characterized in that it is made of thermoplastic polymer, particularly ABS.

Another subject of the present invention is an element characterized in that it is made of polyethylene.

Another subject of the present invention is an element characterized in that it comprises six housings distributed uniformly and in that it has the shape of a rectangular parallelepiped.

Another subject of the present invention is an element characterized in that it comprises twelve housings distributed uniformly and in that it has the shape of a rectangular parallelepiped.

Another subject of the present invention is an element characterized in that it comprises means allowing several elements to be stacked one on top of the other.

Another subject of the present invention is an element characterized in that the said means are grooves extending upwards in the direction of stacking on rims of the storage element.

Another subject of the present invention is an element characterized in that the said means are formed of blocks arranged centrally between several housings, advantageously between four housings, and bearing surfaces projecting from the rims towards the inside of the said element for an element able to be stacked on the said element.

Another subject of the present invention is an element characterized in that the said blocks are formed as an integral part of the housings.

Another subject of the present invention is a brake disc storage module, characterized in that it comprises at least two storage elements according to the present invention, stacked along the longitudinal axis.

The present invention will be better understood with the aid of the description which will follow and the attached figures in which:

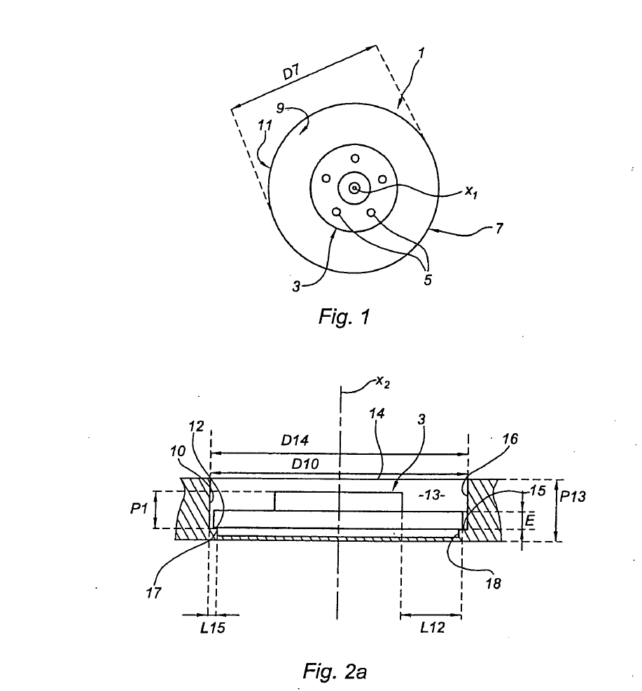

FIG. 1 is a front view of a brake disc of known type;

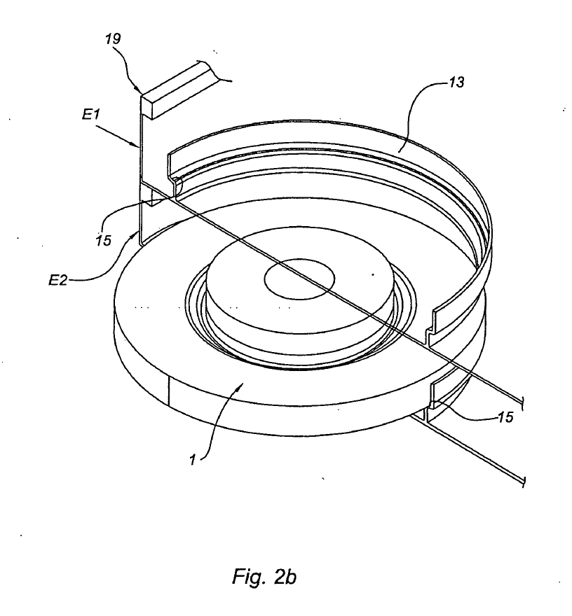

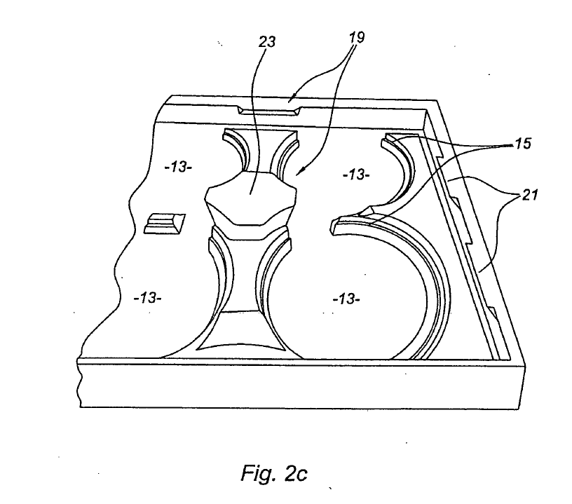

FIG. 2a is a part view of axial section of a first exemplary embodiment of a storage element according to the invention in which a brake disc is arranged;

FIG. 2b is a three quarters view in axial section of a stack of elements according to FIG. 1;

FIG. 2c is a perspective view of a second exemplary embodiment of a storage element according to the present invention;

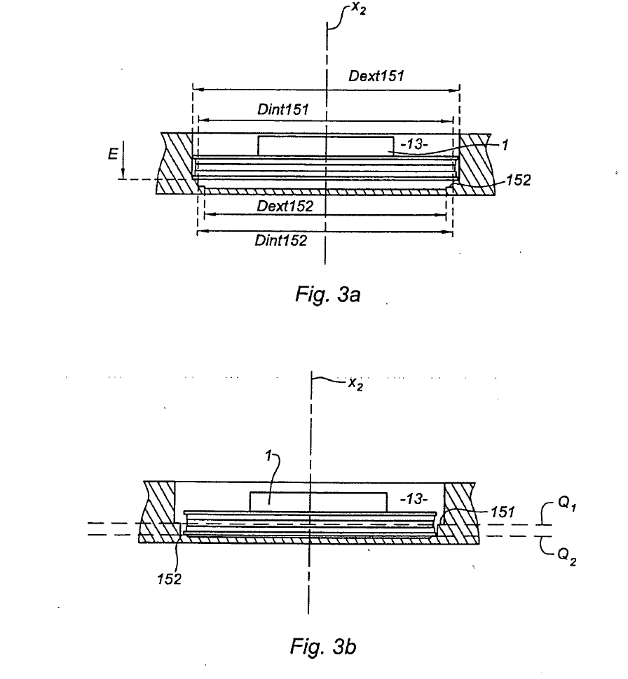

FIG. 3a is a part view in axial section of a detail of a third exemplary embodiment, this also being the preferred exemplary embodiment of a storage element according to the present invention, in which a first type of brake disc is placed;

FIG. 3b is also a part view in axial section of a detail of a preferred exemplary embodiment of a storage element depicted in FIG. 3a in which a second type of brake disc is placed;

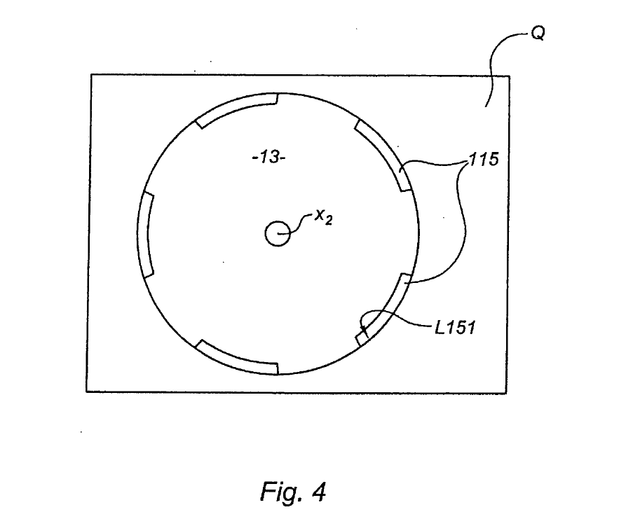

FIG. 4 is a view from above of a fourth exemplary embodiment of a storage element according to the present invention;

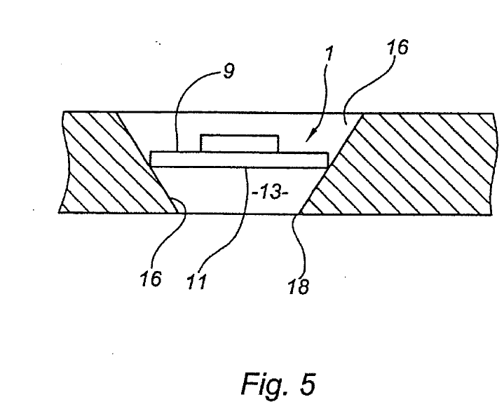

FIG. 5 is a part view in axial section of a fifth exemplary embodiment of a storage element according to the present invention.

FIG. 1 shows a brake disc 1 of known type of axis X1 comprising a first face 9 and a second face 11 of external diameter D7, the first face 9 comprising a central cylindrical portion 3 of axis X1, projecting, allowing the disc to be fixed to the wheel hub of a motor vehicle (not depicted). The cylindrical portion also comprises a main central orifice surrounded by orifices 5 each able to take a bolt (not depicted) integral with the hub, the disc being fixed to the hub by nuts (not depicted) screwed onto the screws. The first and second faces 9, 11 respectively comprise first and second friction tracks of annular shape, against which friction elements of a disc brake (these elements are not depicted) come into contact during a braking action. The first friction track surrounds the cylindrical portion 3.

FIGS. 2a and 2b show a first exemplary embodiment of a storage element for a brake disc according to the present invention comprising a cylindrical housing 13 of axis X2 equipped at an upper first longitudinal end with an opening 14 for inserting the disc into the housing of an internal diameter D14 at least equal to the external diameter D7 of the brake disc and bordered by a wall 16 extending as far as a second longitudinal end 18.

In the exemplary embodiments depicted, the second end 18 of the housing 13 is closed but it is conceivable for the end 18 to be open.

The housing 13 comprises at least one shoulder 15 able to collaborate with a radially external end 17 of the first or second face 9, 11 of the brake disc. The shoulder 15 connects a larger-diameter first part 10 and a smaller-diameter second part 12, the first part 10 being arranged above the second part 12 along the axis X2.

The diameter D10 of the larger-diameter first part 10 is greater than the external diameter D7 of the brake disc, advantageously roughly equal to the diameter D7 of the brake disc so that the disc and the housing remain more or less coaxial, thus making it possible to reduce the movement of the disc in a direction perpendicular to the axis X2 of the housing 13.

In the example depicted, the shoulder 15 is more or less annular with an external diameter equal to the diameter D10 and an internal diameter slightly smaller than the external diameter D7 of the friction track 12.

In other words, the width L15 of the shoulder 15 is small relative to the radius of the brake disc, for example L15 is between 4 mm and 10 mm, preferably between 6 mm and 8 mm, for a brake disc radius of between 135 mm and 150 mm.

In consequence, the surface area of the second face 11 of the brake disc in contact with the storage element is very small, this area representing less than 11% of the total area of the second face of the disc in contact with the shoulder, thus significantly reducing the risk of damage to the surface finish of the brake disc and therefore the risk of creating regions sensitive to corrosion.

In the example depicted, the brake disc is suspended via the second face 11 of the brake disc that has no projecting cylindrical portion. However, it must be clearly understood that suspending the disc from the first face 9 of the brake disc would not constitute a departure from the scope of the present invention. The storage elements are, for example, made of plastic, for example of thermoplastic polymer, for example ABS, by thermoforming, or of PE (polyethylene) or PS/PE (polystyrene/polyethylene). However, it must be clearly understood that elements made of plant materials, for example cardboard, do not constitute a departure from the scope of the present invention.

The distance between the shoulder 15 and the end 14 of the housing 13 is advantageously greater than the dimension P1 along the axis X1 of the brake disc, so as to prevent the brake disc from protruding above the storage element. In the example depicted, the first portion 3, in the example depicted [sic], does not protrude beyond the storage element and does not therefore run the risk of becoming damaged. In addition, when several storage elements are stacked up, it is not the discs that bear the load of the other elements, but the element itself.

Furthermore, as depicted in FIG. 2c, the storage element advantageously comprises several housings 13 for brake discs, for example six or twelve housings 13 distributed uniformly in an element in the shape of a rectangular parallelepiped.

The storage elements also advantageously comprise means 19 allowing several storage elements to be stacked up on top of each other. For example, the means are formed by rims which are sufficiently rigid and tall to allow several storage elements to be stacked.

In FIG. 2b, two storage elements E1 and E2 are visible, the element E1 being stacked on the element E2.

Advantageously, the rims are produced in such a way that they can withstand the stacking of several storage elements. For example, a first storage element can be stacked on a same second storage element, and allow a same third storage element to be stacked on the first storage element, thus allowing a batch of several storage elements to be transported.

The rims are equipped with reinforcing grooves 25 distributed around the periphery of the element so as to allow the element to be self-supporting.

FIG. 2c shows a second exemplary embodiment of an element according to the present invention comprising means to allow several elements to be stacked on top of each other.

The means 19 comprises [sic] at least two blocks 23 arranged respectively in the central part of a region delimited by four housings, the said [lacuna] advantageously being formed as an integral part with the housings 13. An element [sic] comprising 6 housings is advantageously equipped with two blocks and an element comprising twelve housings is equipped with five or six blocks.

The rims are also equipped with surfaces 21 projecting at right angles to the plane of the rims and towards the inside of the element and forming a bearing surface for the element stacked on top.

The blocks also make it easy to grasp hold of the elements, having, for example, a shape making it easier for a fitter or a robot to grasp hold of these elements.

In the example depicted in FIG. 2c, the housings do not have closed circular rims. This is because it is unnecessary for the circular rims to be closed, it is simply necessary for the openings not to allow the disc to move around significantly in a plane orthogonal to the plane of the disc.

FIGS. 3a and 3b depict a third exemplary embodiment of a storage element according to the present invention, this also being the preferred exemplary embodiment in which each housing 13 has at least a first and a second shoulder 151, 152 which shoulders are arranged respectively in two parallel planes Q1, Q2 offset in the direction of the axis X2 to form two steps defining a staircase. The external diameter Dext 152 of the second shoulder 151 is equal to the internal diameter Dint 151 of the first shoulder 151. The internal diameters Dint 151, Dint 152 of the first and second shoulder are chosen respectively so that they are slightly smaller than the largest external diameter of a first and of a second brake disc of different diameters and so that the internal diameter D151 roughly correspond [sic] to the largest external diameter of the second brake disc. This embodiment advantageously allows just one type of storage element to be used for two different types of disc.

Provision is advantageously made for each step to have a dimension along the axis X2 at least equal to half the thickness E of the brake disc corresponding to the distance separating the faces 9 and 11 of the brake disc, thus improving the retention of the brake disc in its housing.

The discs for example have a height of between 12 and 16 mm.

The storage element in FIGS. 3a and 3b allows two types of brake disc, for example discs with diameters of between 277 mm and 295 mm, to be stored.

Of course, a storage element comprising more than two shoulders and therefore able to be used for more than two types of brake disc can be provided.

This then makes it possible to reduce the number of brake disc storage element part numbers, the time spent handling these storage items and the risks of error.

FIG. 4 shows a fourth exemplary embodiment of a storage element according to the present invention, in which the housing comprises at least two support surfaces 115 arranged in one and the same plane Q perpendicular to the axis X2. In the example depicted, the housing 13 comprises three support surfaces 115, formed of angular sectors distributed advantageously angularly, around the periphery of the annular housing and of a width L115 very much smaller than the width of the friction tracks of the brake disc.

FIG. 5 shows a fifth exemplary embodiment of a storage element in which the housing 13 is formed a [sic] cone frustum with the taper directed towards the lower part of the housing so that the peripheral end of the brake disc rests on the frustoconical wall. It is thus possible to use this type of storage for a great many brake discs of different diameters.

The present invention has the advantage of allowing ease of grasping of the brake discs.

There has indeed been produced a motor vehicle brake disc storage element that provides safe storage of the brake discs, that is simple to use and to operate and that has a low cost price.

The present invention mainly involves the private car braking industry.

What is claims is:

1. A storage element for at least one brake disc (1) comprising at least one housing (13) of longitudinal axis (X2), the housing comprising, at a first longitudinal end, an opening (14) for inserting the brake disc (1) having an internal diameter (D14) greater than the external diameter (D7) of the brake disc, a wall (16) connecting the first longitudinal end to a second longitudinal end (18), characterized in that said housing (13) comprises at least one suspension means (15) made in the said wall (16) of the said brake disc so that a non-zero distance separates a first or second face (9, 11) of the brake disc, facing towards the second longitudinal end of the housing (13) and said second end (18).

2. The storage element for a brake disc according to claim 1, characterized in that said suspension means is formed by at least one shoulder (15) connecting a larger-diameter first cylindrical portion (10) of the longitudinal axis (X2) of a diameter greater than the diameter (D7) of the brake disc (7) and a smaller-diameter second portion (12) of the longitudinal axis (X2), said shoulder being of width (L) such that the shoulder collaborates with a radially external end (17) of said first or second face (9, 11) of the brake disc.

3. The storage element according to claim 2, characterized in that said shoulder (15) is made of at [sic] two parts (115) arranged in one and the same plane (Q) and formed by angular sectors distributed, advantageously uniformly, over the periphery of the housing (13).

4. The storage element for a brake disc according to claim 2, characterized in that said housing (13) comprises several shoulders (151, 152) arranged in parallel planes (Q1, Q2) so that the storage element will take brake discs of different diameters.

5. The storage element according to claim 4, characterized in that each shoulder (151, 152) connects a larger-diameter part to a smaller-diameter part, said smaller-diameter part forming the next larger-diameter part, and in that each larger-diameter part has an axial dimension along the axis (X2) at least equal to half the distance separating said first and second faces (9, 11) of the brake disc it accommodates.

6. The storage element for a brake disc according to claim 5, characterized in that the smaller-diameter portion of said suspension means along the longitudinal axis (X2) from the first end (14) of the housing (13) towards the second end (18) forms the larger-diameter portion of a next suspension means.

7. The storage element for a brake disc according to claim 6, characterized in that the width of the said shoulder (15, 151, 152) is preferably between 4 mm and 10 mm.

8. The storage element according to claim 7, characterized in that the width of said shoulder (15, 151, 152) is more preferably still between 6 mm and 8 mm.

9. The storage element for a brake disc according to claim 1, characterized in that said wall (16) is in the form of a cone frustum with the taper directed towards the second longitudinal end (18) of the housing.

10. The storage element according to claim 9, characterized in that said housing (13) has a dimension along the axis (X2) at least equal to the dimension of the brake disc along the axis (X1).

11. The storage element according to claim 10, wherein the element is made of a synthetic material by thermoforming.

12. The storage element according to claim 10, wherein the element is made of thermoplastic polymer, particularly ABS.

13. The storage element according to claim 10, wherein the element is made of polyethylene.

14. The storage element according to claim 10, wherein the element comprises six housings (13) distributed uniformly and in that the element has the shape of a rectangular parallelepiped.

15. The storage element according to claim 1, characterized in that the element comprises twelve housings (13) distributed uniformly and in that the element has the shape of a rectangular parallelepiped.

16. The storage element according to claim 1, characterized in that the element comprises means (19) allowing several elements to be stacked one on top of the other.

17. The storage element according to claim 16, characterized in that said means (19) are grooves extending upwards in the direction of stacking on rims of the storage element.

18. The storage element according to claim 16, characterized in that said means are formed of blocks (23) arranged centrally between several housings, advantageously between four housings, and bearing surfaces (21) projecting from the rims towards the inside of said element for an additional element able to be stacked on the said element.

19. The storage element according to claim 18, characterized in that said blocks are formed as an integral part of the housings.

20. The storage element according to claim 19 comprises at least two storage elements stacked along the axis (X2).
